(19) United States
(12) Patent Application Publication
(10) Pub. No.: US 2005/0087042 A1
(43) Pub. Date: Apr. 28, 2005

(54) Sleeve assembly for turning bolts or nuts of different sizes and/or having different heads

(76) Inventor: De Lun Huang, Ta-Le City (TW)

Correspondence Address: Keith Kline;PRO-TECHTOR INTERNATIONAL SERVICES, 20775 Norada Court, Saratoga, CA, 95070-3018, US

(21) Appl. No.: 10/691,992

(22) Filed: Oct. 22, 2003

(51) Int. Cl. B25B 13/00

(52) U.S. Cl. 81/124.5

(57) ABSTRACT

A sleeve assembly for turning fasteners of different sizes and/or having different heads is disclosed. The assembly comprises an outer sleeve including two sets of first and second holes at opposite sides; a plurality of inner sleeves sleeved together, each inner sleeve including two apertures at opposite sides and two elongate slots proximate the apertures; a level inserted through the first holes and the apertures; and a pin disposed across the second holes and lower ends of the slots. Removing the level and the pin, pulling one inner sleeve having a bore conformed to the head of a fastener, and inserting the level and the pin into their original positions again with a movement of a top end of the chosen inner sleeve being limited by the level, and putting the chosen inner sleeve onto the head of the fastener will turn the fastener by rotating the level.

### BACKGROUND OF THE INVENTION

1. Field of the Invention

The present invention relates to tool sets and more particularly to an improved sleeve assembly for turning bolts or nuts of different sizes and/or having different heads.

2. Description of Related Art

Conventionally, a sleeve is adapted to quickly assemble with one end of one of a number of tools of different sizes so that the other end of the chosen tool can hold and turn a bolt or nut. Thus, it is typical for a worker carrying a tool set containing a number of different tools and a cooperating sleeve. However, the prior art suffered from several disadvantages. For example, one or more tools may be lost after a number of times of use. It is understood that this can bring troubles to a user, especially when the lost tool is required for a specific work. Also, carrying both the sleeve and the tool set by a person is not convenient. Hence, a need for improvement exists.

### SUMMARY OF THE INVENTION

It is an object of the present invention to provide a sleeve assembly comprising an outer sleeve including two first holes at two opposite sides and two second holes at the same sides as the first holes, a bore of the second hole being smaller than that of the first hole; a plurality of inner sleeves having different bores, each inner sleeve including two third holes at two opposite sides, the third hole having the same size as the first hole, and two elongate slots at the same sides as the third holes wherein any larger inner sleeve is sleeved on a next smaller inner sleeve; a level inserted through the first holes and the third holes; and a pin disposed across the second holes and lower ends of the slots to be flush with an opening of either second hole, whereby either putting the inner most inner sleeve onto a fastener having a head conformed to the bore of the inner most inner sleeve or performing operations of removing the level and the pin from the sleeve assembly, pulling one of the inner sleeves having a bore conformed to the head of the fastener, and inserting the level and the pin into their original positions again with a movement of a top end of the chosen inner sleeve being limited by the level, and putting the chosen inner sleeve onto the head of the fastener will enable a turning of the head of the fastener by rotating the level. By utilizing the present invention, it is possible of turning fasteners (e.g., bolts or nuts) of different sizes and/or having different heads by using a unitary device.

It is another object of the present invention to provide a sleeve assembly comprising an outer sleeve including two first holes at two opposite sides and two second holes at the same sides as the first holes, a bore of the second hole being smaller than that of the first hole; a plurality of inner sleeves having different bores, each inner sleeve including two elongate grooves at two opposite sides wherein any larger inner sleeve is sleeved on a next smaller inner sleeve; a level inserted through the first holes to be in contact with top ends of the inner sleeves; and a pin disposed across the second holes and lower ends of the slots to be flush with an opening of either second hole, whereby either putting the inner most inner sleeve onto a fastener having a head conformed to the bore of the inner most inner sleeve or performing operations of removing the level from the sleeve assembly, pushing one or more inner sleeves inwardly until being stopped by a top end of the sleeve assembly and lower ends of the pushed one or more inner sleeves being stopped by the pin, thereby leaving, a bore within the sleeve assembly conformed to the head of the fastener, inserting the level into its original position again, and putting the sleeve assembly onto the head of the fastener will enable a turning of the head of the fastener by rotating the level.

In one aspect of the present invention each of the outer sleeve and the inner sleeves has a section of hexagon, triangle, square, or circle.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of sleeve assembly for turning bolts or nuts of different sizes and/or having different heads according to the invention;

FIG. 2 is a cross-sectional view of the sleeve assembly shown in FIG. 1;

FIG. 3 is an exploded view of the sleeve assembly shown in FIG. 1;

FIG. 4 is a view similar to FIG. 2 in which a bolt is held by one of the inner sleeves;

FIG. 5 is an exploded view of a second preferred embodiment of sleeve assembly according to the invention;

FIG. 6 is an exploded view of the sleeve assembly shown in FIG. 5; and

FIG. 7 is a cross-sectional view of the sleeve assembly shown in FIG. 5 in which the head of a bolt is held within the sleeve assembly.

### DETAILED DESCRIPTION OF THE PREFERRED EMBODIMENTS

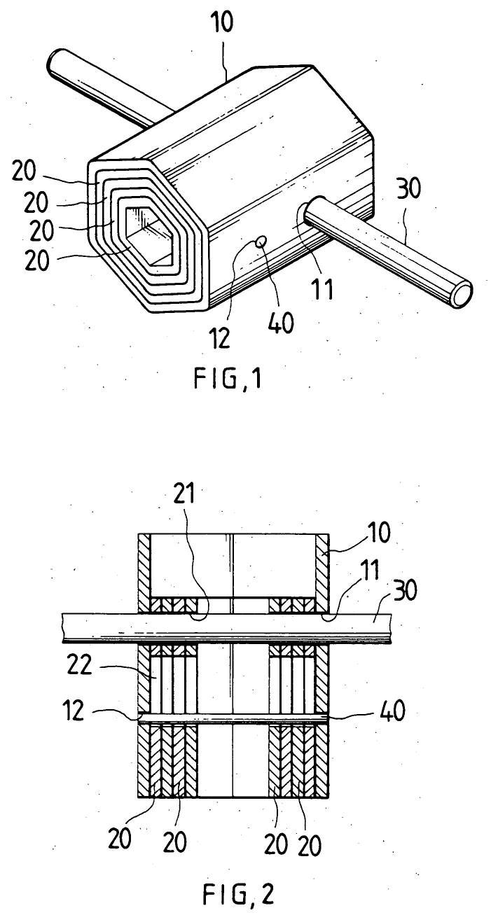

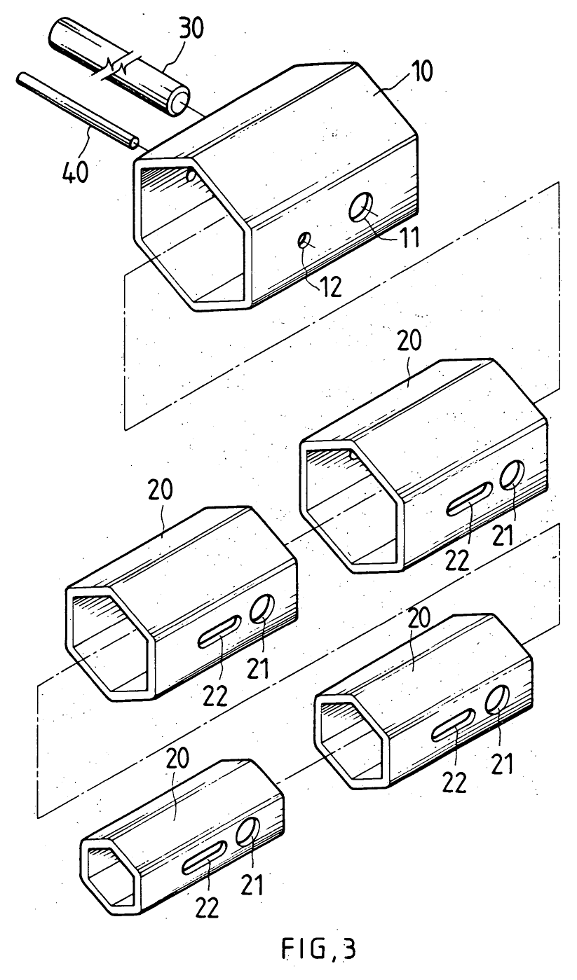

Referring to FIGS. 1 to 4, a sleeve assembly constructed in accordance with a first preferred embodiment of the invention is shown. The sleeve assembly comprises a hexagonal outer sleeve 10 including two first holes 11 at two opposite sides and two second holes 12 at the same sides as the first holes 11, the bore of the second hole 12 being smaller than that of the first hole 11; a plurality of hexagonal inner sleeves 20 (four are shown) having different bores, each inner sleeve 20 including two third holes 21 at two opposite sides, the third hole 21 having the same size as the first hole 11, and two elongate slots 22 at the same sides as the third holes 21 in which any larger inner sleeve 20 is sleeved on a next smaller inner sleeve 20; a level 30 inserted through the first holes 11 and the third holes 21; and a pin 40 disposed across the second holes 12 and the lower ends of the slots 22 to be flush with the opening of either second hole 12. The components of the sleeve assembly are coupled together in the positions shown in FIGS. 1, 2, and 4.

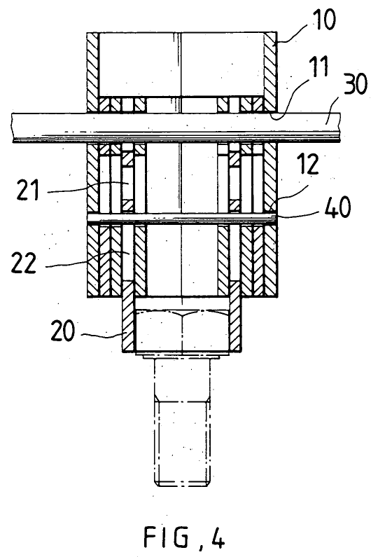

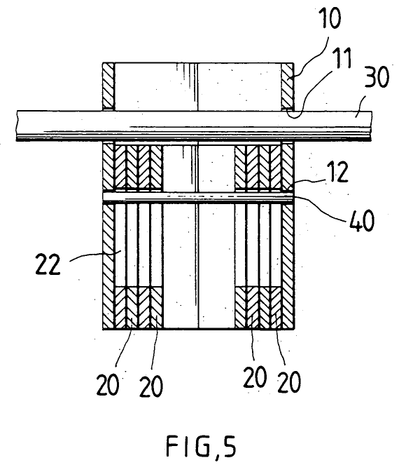

Referring to FIG. 4 specifically, an operation of the first embodiment of the invention will now be described in detail below. A user can put the inner most inner sleeve 20 onto a bolt having a head conformed to the bore of the inner most inner sleeve 20. Otherwise, the user has to perform the following steps for turning the bolt. First, the user removes the level 30 and the pin 40 from the sleeve assembly. Next, pull one of the inner sleeves 20 having a bore conformed to the head of the bolt. The allowable pulling distance of the inner sleeve 20 is designed to sufficiently fit the head of one of many conventional bolts (or nuts) therein. Next, insert the level 30 and the pin 40 again into their original positions. At this position, the chosen inner sleeve 20 is allowed to travel only a small longitudinal distance since the movement of the top end of the chosen inner sleeve 20 is limited by the level 30. Next, put the chosen inner sleeve 20 onto the head of the bolt. Finally, the user can turn the bolt by rotating the level 30 for fastening or unfastening. In the embodiment, each of the outer sleeve 10 and the inner sleeves 20 has a section of hexagon, while it is appreciated by those skilled in the art that each of the outer sleeve 10 and the inner sleeves 20 may have a section of triangle, square, circle, or any of other shapes in other embodiments without departing from the scope and spirit of the invention.

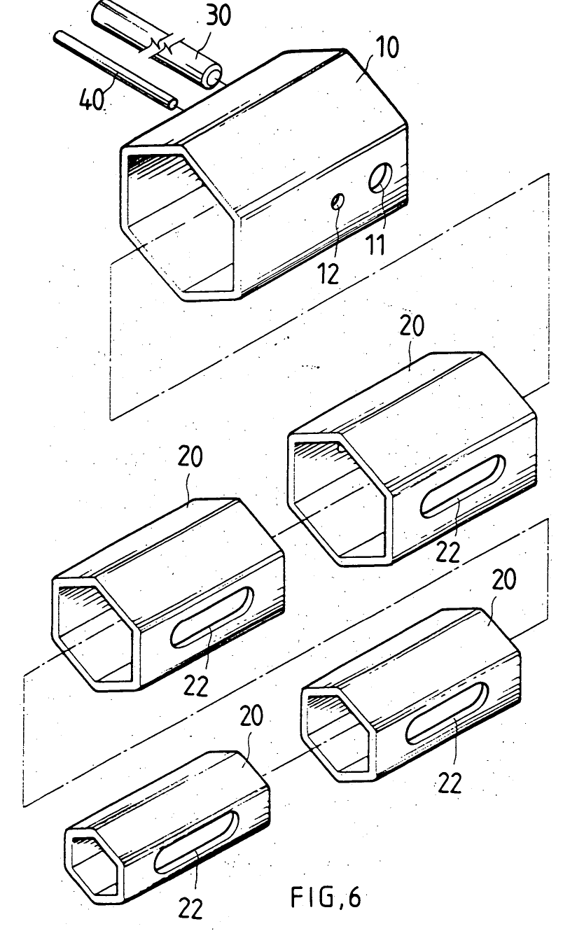

Referring to FIGS. 5 and 6, a sleeve assembly constructed in accordance with a second preferred embodiment of the invention is shown. The second preferred embodiment substantially has same structure as the first preferred embodiment. The differences between the first and the second preferred embodiments, i.e., the characteristics of the second preferred embodiment are detailed below. Each inner sleeve 20 has two elongate grooves 22 at two opposite sides as a replacement of the first holes 11 and the second holes 12. The level 30 is inserted through the first holes 11 and is in contact with the top ends of the inner sleeves 20. The pin 40 is disposed across the second holes 12 and the upper ends of the slots 22 to be flush with the opening of either second hole 12.

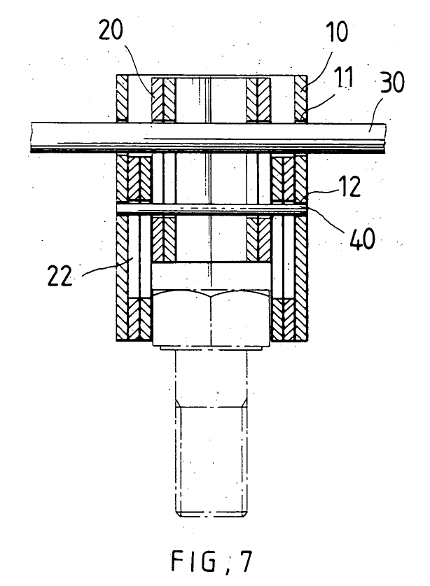

Referring to FIG. 7, an operation of the second embodiment of the invention will now be described in detail below. A user can put the inner most inner sleeve 20 onto a bolt having a head conformed to the bore of the inner most inner sleeve 20. Otherwise, the user has to perform the following steps for turning the bolt. The user first removes the level 30 from the sleeve assembly. Next, push two inner sleeves 20 inwardly until they are stopped by the top end of the sleeve assembly and the lower ends of the pushed inner sleeves 20 are stopped by the pin 40, thereby leaving a bore within the sleeve assembly conformed to the head of the bolt. Next, insert the level 30 again into its original position. Next, put the sleeve assembly onto the head of the bolt. Finally, the user can turn the bolt by rotating the level 30 for fastening or unfastening.

While the invention herein disclosed has been described by means of specific embodiments, numerous modifications and variations could be made thereto by those skilled in the art without departing from the scope and spirit of the invention set forth in the claims.

1. A sleeve assembly, comprising:
an outer sleeve including two first holes at two opposite sides and two second holes at the same sides as the first holes, a bore of the second hole being smaller than that of the first hole;
a plurality of inner sleeves having different bores, each inner sleeve including two third holes at two opposite sides, the third hole having the same size as the first hole, and two elongate slots at the same sides as the third holes wherein any larger inner sleeve is sleeved on a next smaller inner sleeve;
a level inserted through the first holes and the third holes; and
a pin disposed across the second holes and lower ends of the slots to be flush with an opening of either second hole,
whereby either putting the inner most inner sleeve onto a fastener having a head conformed to the bore of the inner most inner sleeve or performing operations of removing the level and the pin from the sleeve assembly, pulling one of the inner sleeves having a bore conformed to the head of the fastener, and inserting the level and the pin into their original positions again with a movement of a top end of the chosen inner sleeve being limited by the level, and putting the chosen inner sleeve onto the head of the fastener will enable a turning of the head of the fastener by rotating the level.

2. The sleeve assembly of claim 1, wherein each of the outer sleeve and the inner sleeves has a section of hexagon.

3. The sleeve assembly of claim 1, wherein each of the outer sleeve and the inner sleeves has a section of square.

4. The sleeve assembly of claim 1, wherein each of the outer sleeve and the inner sleeves has a section of triangle.

5. The sleeve assembly of claim 1, wherein each of the outer sleeve and the inner sleeves has a section of circle.

6. The sleeve assembly of claim 1, wherein the fastener is a bolt.

7. The sleeve assembly of claim 1, wherein the fastener is a nut.

8. A sleeve assembly, comprising:
an outer sleeve including two first holes at two opposite sides and two second holes at the same sides as the first holes, a bore of the second hole being smaller than that of the first hole;
a plurality of inner sleeves having different bores, each inner sleeve including two elongate grooves at two opposite sides wherein any larger inner sleeve is sleeved on a next smaller inner sleeve;
a level inserted through the first holes to be in contact with top ends of the inner sleeves; and
a pin disposed across the second holes and upper ends of the slots to be flush with an opening of either second hole,
whereby either putting the inner most inner sleeve onto a fastener having a head conformed to the bore of the inner most inner sleeve or performing operations of removing the level from the sleeve assembly, pushing one or more inner sleeves inwardly until being stopped by a top end of the sleeve assembly and lower ends of the pushed one or more inner sleeves being stopped by the pin, thereby leaving a bore within the sleeve assembly conformed to the head of the fastener, inserting the level into its original position again, and putting the sleeve assembly onto the head of the fastener will enable a turning of the head of the fastener by rotating the level.

9. The sleeve assembly of claim 8, wherein each of the outer sleeve and the inner sleeves has a section of hexagon.

10. The sleeve assembly of claim 8, wherein each of the outer sleeve and the inner sleeves has a section of square.

11. The sleeve assembly of claim 8, wherein each of the outer sleeve and the inner sleeves has a section of triangle.

12. The sleeve assembly of claim 8, wherein each of the outer sleeve and the inner sleeves has a section of circle.

13. The sleeve assembly of claim 8, wherein the fastener is a bolt.

14. The sleeve assembly of claim 8, wherein the fastener is a nut.
